(19) United States
(12) Patent Application Publication
(10) Pub. No.: US 2016/0147369 A1
(43) Pub. Date: May 26, 2016

(54) APPARATUS FOR CONTROLLING VIRTUAL OBJECT BASED ON TOUCHED TIME AND METHOD THEREOF

(71) Applicant: INNOSPARK INC., Seoul (KR)

(72) Inventor: Jaechan SHIN, Gyeonggi-do (KR)

(73) Assignee: INNOSPARK INC., Seoul (KR)

(21) Appl. No.: 14/946,774

(22) Filed: Nov. 20, 2015

(30) Foreign Application Priority Data
Nov. 20, 2014 (KR) 10-2014-0162464

(51) Int. Cl. G06F 3/041

(52) U.S. Cl. CPC G06F 3/0416; G06F 3/0412

(57) ABSTRACT

A method and apparatus for controlling a virtual object based on a touched time are provided. The apparatus includes a touch recognizing part configured to recognize a touch input on a touch screen, and an area setting part configured to set a selection area in a virtual space based on the touch input. The area setting part sets the selection area according to a first spot and a touched time, the first spot being a point at which a first touch input is applied on the touch screen and the touched time being a time period during which the first touch input is maintained.

### CROSS REFERENCE TO PRIOR APPLICATION

This application claims the benefit of Korean Patent Application No. 10-2014-0162464, filed on Nov. 20, 2014, which is hereby incorporated by reference as if fully set forth herein.

### BACKGROUND

1. Field of the Invention

The present invention relates generally to an apparatus and method for controlling a virtual object, and more particularly, to an apparatus and method for selecting a virtual object in a virtual space based on a touched time and controlling the selected virtual object.

2. Discussion of the Related Art

Along with the development of communication technology, techniques based on wireless communication technology have recently been used widely in all industrial fields including a service field as well as a communication field. Therefore, a variety of services are provided through a wireless communication network, inclusive of voice call, data transmission, the Internet, and virtual space.

Most of the services based on the wireless communication network are provided to users through touch screen-based smart phones or tablet Personal Computers (PCs). Although traditionally, a user input is applied through a mouse and a keyboard, most of user inputs are now applied through a touch screen.

However, an action such as dragging of a mouse is not made easily with such a touch input. To set a specific area on a touch screen, a function for setting an area is separately required, as illustrated in FIG. 1. In this case, with an area setting window executed, an area is adjusted by moving each side of the area setting window.

That is, a user should conduct an area setting process to set a specific area at one time, as is done with dragging of a mouse. Moreover, the user may feel inconvenient because the user may not set the specific area as readily as dragging of a mouse.

### SUMMARY

Accordingly, the present invention is directed to an apparatus and method for controlling a virtual object based on a touched time that substantially obviate one or more problems due to limitations and disadvantages of the related art.

An object of the present invention is to provide a user interface that enables easy setting of a specific area on a touch screen utilizing factors of a touch input and a touched time.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve the object and other advantages and in accordance with the purpose of the invention, as embodied and broadly described herein, an apparatus for controlling a virtual object based on a touched time includes a touch recognizing part configured to recognize a touch input on a touch screen, and an area setting part configured to set a selection area in a virtual space based on the touch input. The area setting part sets the selection area based on a first spot and a touched time, the first spot being a spot at which a first touch input is applied on the touch screen and the touched time being a time period during which the first touch input is maintained.

The apparatus may further include a virtual object selecting part configured to select a virtual object in the selection area.

The area setting part may extend the selection area with respect to the first spot based on the touched time.

The area setting part may extend a virtual object area with respect to a second spot different from the first spot based on the touched time.

The first spot may be a part of a function menu on the touch screen, and the second spot may be a predetermined virtual object.

The virtual object may include a virtual character or a building in the virtual space.

The apparatus may further include a virtual object controlling part configured to, if at least one virtual object is selected and then a second touch input is applied at a third spot, control the selected virtual object to move to or attack the third spot. The third spot may be a point accessible to the virtual object.

The apparatus may further include a virtual object controlling part configured to, if at least one virtual object is selected and then a second touch input is applied at a third spot, cancel the selection. The third spot may be a point inaccessible to the virtual object.

According to another aspect of the present invention, a method for controlling a virtual object based on a touched time includes receiving a first touch input through a touch screen, and selecting a virtual object in a virtual space based on a first spot and a touched time by a controlling part, the first spot being a spot at which a first touch input is applied on the touch screen and the touched time being a time period during which the first touch input is maintained.

The method may further include extending an object selection range with respect to the first spot based on the touched time.

The method may further include extending the virtual object selection range with respect to a second spot different from the first spot based on the touched time.

The first spot may be a part of a function menu on the touch screen, and the second spot may be a predetermined virtual object.

The virtual object may include a virtual character or a building in the virtual space.

If at least one virtual object is selected and then a second touch input is applied at a third spot, the controlling part may control the selected virtual object to move to or attack the third spot, and the third spot may be a point accessible to the virtual object.

If at least one virtual object is selected and then a second touch input is applied at a third spot, the controlling part may cancel the selection, and the third spot may be a point inaccessible to the virtual object.

According to another aspect of the present invention, a computer program may include a command to perform the above method for controlling a virtual object based on a touched time.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a conventional method for selecting an area;

FIG. 2 is a block diagram illustrating an interior configuration of an apparatus 1 for controlling a virtual object based on a touched time according to an embodiment of the present invention;

FIG. 3 illustrates a screen displayed on a touch screen, referred to for describing an action for selecting a virtual object based on a touched time according to an embodiment of the present invention;

FIG. 4 illustrates another method for setting a selection area according to an embodiment of the present invention; and

FIG. 5 is a flowchart illustrating a method for controlling a virtual object based on a touched time according to an embodiment of the present invention.

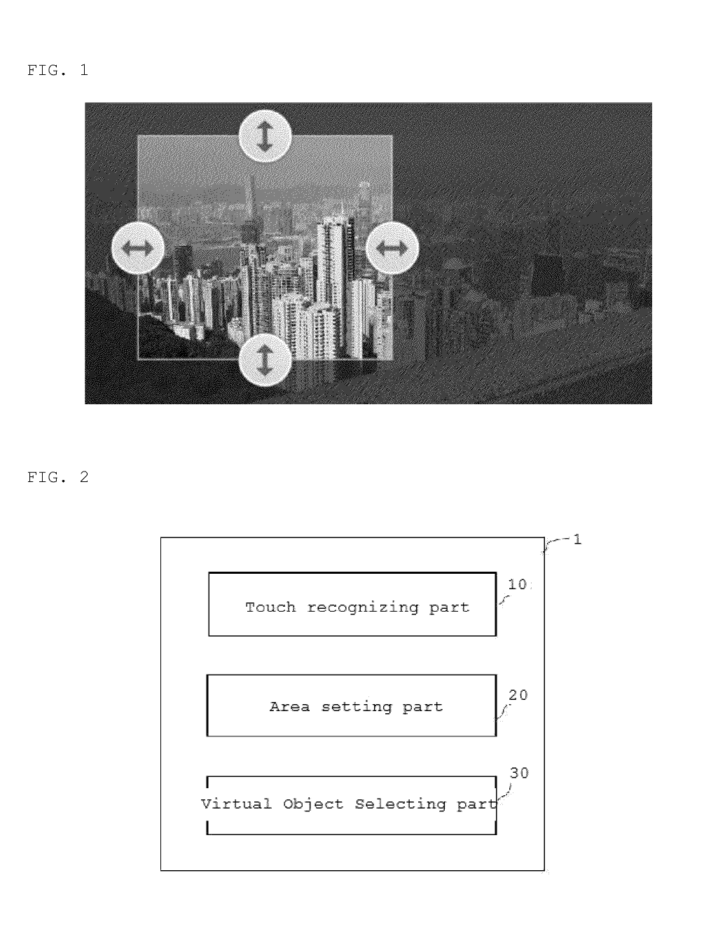

### DETAILED DESCRIPTION

A detailed description of the present invention is given below with reference to the attached drawings illustrating exemplary specific embodiments of the present invention. These embodiments are described in detail so that those skilled in the art may implement the present invention. It is to be understood that although various embodiments of the present invention are different, they do not need to be mutually exclusive. For example, a specific shape, structure, and feature according to an embodiment, disclosed in the present specification may be realized in another embodiment within the scope and spirit of the present invention. Further, it is to be understood that the positions or layout of individual components in each embodiment may be modified without departing from the scope and spirit of the present invention. Accordingly, the following detailed description is not intended to be restrictive, and the scope of the present invention should be determined by the appended claims and their legal equivalents. Like reference numerals denote the same or similar functions in a plurality of aspects.

The embodiments disclosed in the present invention may have implemented fully in hardware, partially in hardware and partially in software, or fully in software. The term as used herein, ‘unit’, ‘module’, ‘device’, or ‘system’ refers to a computer-related entity such as hardware, a combination of hardware and software, or software. For example, a unit, a module, a device, or a system may be, but not limited to, an on-going process, a processor, an object, an executable file, a threshold of execution, a program, and/or a computer in the present disclosure. For example, both an ongoing application executed in a computer and the computer may correspond to a unit, a module, a device, or a system.

The embodiments are described with reference to the illustrated flowcharts. While the methods are illustrated and described in block forms, for simplicity of description, the present invention is not limited to the sequence of the blocks. Some blocks and other blocks may take place simultaneously or in a different order from that illustrated and described in the present disclosure, and various other branches, flow paths, and block orders may be achieved, for the same or similar results. Also, all blocks shown for implementation of the methods described in the present disclosure may not be required. Further, a method according to an embodiment of the present invention may be implemented in the form of a computer program for executing a series of steps and the computer program may be recorded to a computer-readable recording medium.

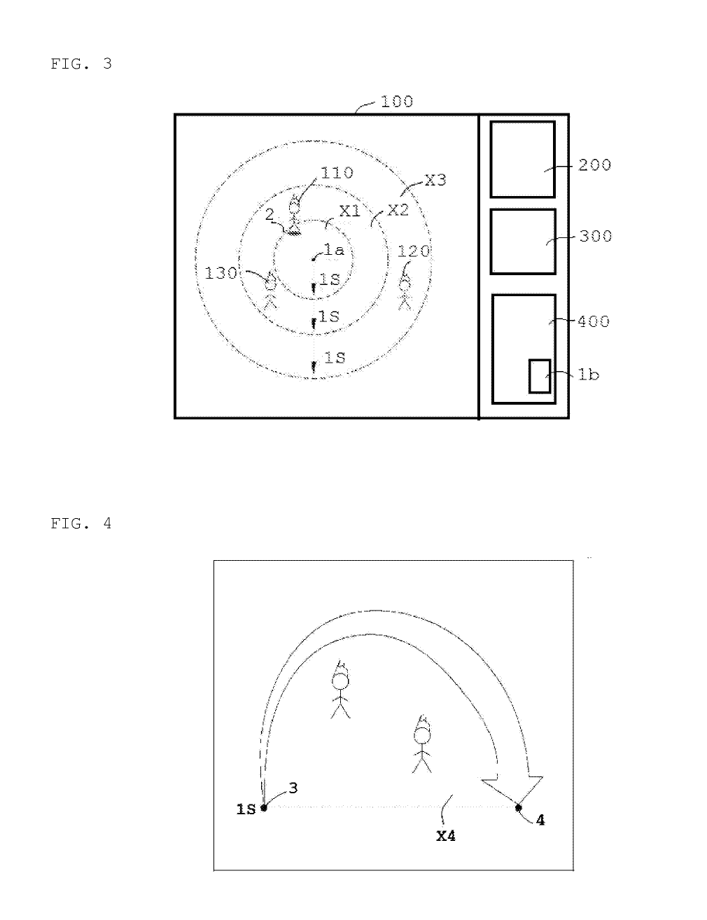

FIG. 2 is a block diagram illustrating an interior configuration of an apparatus 1 for controlling a virtual object based on a touched time according to an embodiment of the present invention. The touched time-based virtual object control apparatus 1 may include a touch recognizing part 10 for recognizing a touch input on a touch screen, and an area setting part 20 for setting a selection area in a virtual space based on the touch input. The area setting part 30 may set the selection area based on a first spot at a first touch input is applied on the touch screen and a touched time during which the touch input is maintained.

The touched time-based virtual object control apparatus 1 may further include a virtual object selecting part 30 for selecting a virtual object in the selection area. While not shown, the touched time-based virtual object control apparatus 1 may include a memory for storing data.

The touched time-based virtual object control apparatus 1 may be implemented in various manners and may include various features. The touched time-based virtual object control apparatus 1 may include any device for playing a specific game or executing a specific application, not limited to any specific configuration.

The virtual space may be, but not limited to, a virtual space of a game. The virtual space may be a virtual space in which various applications are executed.

An application, that is, a program may be executed in the touched time-based virtual object control apparatus 1, using a storage function, a computation function, etc. of the touched time-based virtual object control apparatus 1. For example, the touched time-based virtual object control apparatus 1 may include any handheld wireless terminal such as a Personal Communication System (PCS), a Global System for Mobile communications (GSM), a Personal Digital Cellular (PDC), a Personal Handyphone System (PHS), a Personal Digital Assistant (PDA), and an International Mobile Telecommunication-2000 (IMT-2000). Particularly, the touched time-based virtual object control apparatus 1 may be a smartphone or a small-size smart pad under circumstances, which includes a display, various sensors such as a touch sensor, a vibration motor, a speaker, and a communication module. Further, the touched time-based virtual object control apparatus 1 may include a processing system with a processor, an Operating System (OS), and an Application Programming Interface (API), for providing communication between one or more software applications and the OS. The processing system of the touched time-based virtual object control apparatus 1 may also be configured to execute various software applications.

The touched time-based virtual object control apparatus 1 may communicate with another object. For this purpose, hardware or software may be loaded in the touched time-based virtual object control apparatus 1. The communication may be conducted in conformance to any communication scheme that enables networking of objects, not limited to wired/wireless communication, 3^{rd} Generation (3G) communication, 4^{th} Generation (4G) communication, or any other communication scheme. All transmittable/receivable information including various sensor information, voice feedback information, and vibration feedback information in the touched time-based virtual object control apparatus 1 may be transmitted to an external object or an internal component. The communication may be conducted according to, but not limited to, one or more communication schemes selected from a group of Wireless Local Area Network (WLAN), Metropolitan Area Network (MAN), Global System for Mobile communication (GSM), Enhanced Data GSM Environment (EDGE), High Speed Downlink Packet Access (HSDPA), Wideband Code Division Multiple Access (WCDMA), CDMA, Time Division Multiple Access (TDMA), Bluetooth, Zigbee, Wireless Fidelity (Wi-Fi), Voice over Internet Protocol (VoIP), Long Term Evolution (LTE)-Advanced (LTE-A), Mobile Worldwide Interoperability for Microwave Access (Mobile WiMAX) (IEEE 802.16e), UMB (formerly EV-DO Rev, C), Flash-Orthogonal Frequency Division Multiplexing (Flash-OFDM), iBurst and Mobile Broadband Wireless Access (MBWA) (IEEE 802.10), HIPERMAN, Beam Division Multiple Access (BDMA), WiMAX, and ultrasonic communication.

The OS of the touched time-based virtual object control apparatus 1 may be, but not limited to, Android of Google, Blackberry of RIM, iOS of Apple, Symbian of Nokia, Windows Mobile of Microsoft, or Bada of Samsung Electronics.

A touch screen (not shown) configured to receive a touch input receives a touch input of a user. In an embodiment, the touch input may be applied in the form of a state such as the position of a touched point, a new point, a moved point, a released point, and the like, or a touch gesture such as tab, double tab, panning, flicking, drag and drop, pinching, stretching, and the like.

The touch screen may be a Liquid Crystal Display (LCD), a Plasma Display Panel (PDP) display, or a projector display. The touch screen may include a Three-Dimensional (3D) display based on autostereography like a shutter glasses scheme, a lenticular scheme, and a parallax barrier scheme, or using a hologram. Also, a Light Emitting Diode (LED), an Organic LED (OLED), a Light Emitting Polymer (LEP), an Electro-Luminescence Element (EL Element), a Field Emission Display (FED), or a Polymer LED (PLED) may be applied to the touch screen.

The touch recognizing part 10, the area setting part 20, and the virtual object selecting part 30 may be included in a computable processor such as a Central Processing Unit (CPU).

According to the present invention, the touch recognizing part 10, the area setting part 20, and the virtual object selecting part 30 may be incorporated into a single controlling part.

The touch recognizing part 10 may recognize a touch input on the touch screen. That is, the touch recognizing part 10 may determine a touched spot and a touched time by sensing a touch input on the touch screen and may provide the determined data to another component.

The area setting part 20 may set a selection area in a virtual space based on a first spot at which a first touch is input on the touch screen and a touched time during the first touch input is maintained. The term ‘first touch’ is used to distinguish the touch from a later-described ‘second touch’ and ‘third touch’, not meaning the first touch applied to the touch screen.

The virtual object selecting part 30 may select a virtual object in the selection area. Specifically, the virtual object may be in a state where it may be operated according to a user command. If a plurality of virtual objects are to be selected, a group of virtual objects that may be operated at one time may be selected.

FIG. 3 illustrates a screen displayed on a touch screen, referred to for describing a method for selecting a virtual object based on a touched time according to an embodiment of the present invention. Referring to FIG. 3, a virtual space displayed on the touch screen may include a play unit 100, a mini map unit 200, a setting menu unit 300, and a manipulation unit 400. The mini map unit 200, the setting menu unit 300, and the manipulation unit 400 may be hidden normally and displayed in response to a specific command such as a touch on an edge or selection of a specific virtual object.

The play unit 100 is a screen on which a virtual space is defined. Virtual objects may be displayed on the play unit 100. The mini map unit 200 may display a whole map on which the virtual space is defined, including the virtual space screen displayed on the play unit 100. The setting menu unit 300 may include virtual buttons for executing the functions of storing, loading, and terminating a virtual space. The manipulation unit 400 may include virtual buttons for displaying the functions of moving, attaching, recovering, and building virtual objects, which may be executed by virtual objects, and for issuing commands. In the present invention, a virtual object may include, but not limited to, a virtual character or a building in a virtual space.

The area setting part 20 may extend the range of a selection area in which a virtual object is selected, with respect to the first spot based on the touched time. Referring to FIG. 3, a plurality of virtual objects 110, 120, and 130 are displayed on the play unit 100. If a user touches a first spot 1a and keeps the first spot 1a touched, the virtual object selection area may be extended gradually. For example, upon expiration of one second with the first spot 1a touched, the selection area may become X1. After one more second elapses, the selection area may become X2. Then after one more second elapses again, the selection area may become X3. As a consequence, although only the virtual object 110 is selected after one second, both the virtual objects 110 and 130 may be selected after two seconds and all of the virtual objects 110, 120, and 130 may be selected after three seconds.

The above-described touched time periods and the resulting increased sizes of a selection area may be predetermined in various manners. While a virtual object selection area is shown as a circle in FIG. 2, the present invention is not limited thereto and various shapes are available as the virtual object selection area.

The controlling part may extend the virtual object selection range with respect to a second spot 2 different from the first spot 1b based on the touched time. The first spot 1b may be a part of a function menu on the touch screen and the second spot 2 may be a predetermined virtual object. The function menu may be included in the manipulation unit 400.

For example, when a specific button from among the buttons of the manipulation unit 400 is touched, the specific virtual object 110 may be selected. If the touched state is maintained, the virtual object selection area may be extended according to the touched time, with respect to the virtual object 110. In this case, the circular selection area may be extended gradually around the virtual object 110.

That is, if a spot is touched on the play unit 100, a selection area may be extended around the touched spot. Or if a button of the setting menu unit 300 is touched, a virtual object corresponding to the touched button may be selected and the selection area may be extended around the virtual object. For example, the virtual object may be a character having a special function among various virtual space characters, or a building.

The touched time-based virtual object control apparatus 1 may further include a virtual object controlling part (not shown) for, when at least one virtual object is selected and then a second touch is input at a third spot, controlling the selected virtual object to move to or attack the third spot. The third spot is a spot accessible to the virtual object. For example, if one or more virtual objects are selected and a point accessible to the virtual objects is touched on the play unit 100, a move command or an attack command may be issued for the selected virtual objects. While only the move command or the attack command has been described above, the present invention is not limited to the move command or the attach command. The present invention may include any other command executable by a character in a Role Playing Games (RPG) virtual space.

If at least one virtual object is selected and then a second touch is input at a third spot, the virtual object controlling part may cancel the selection. Herein, the third spot may be inaccessible to the virtual object. For example, if at least one virtual object is selected and then a spot inaccessible to the virtual object is touched on the play unit 100, the selection of the virtual object may be canceled.

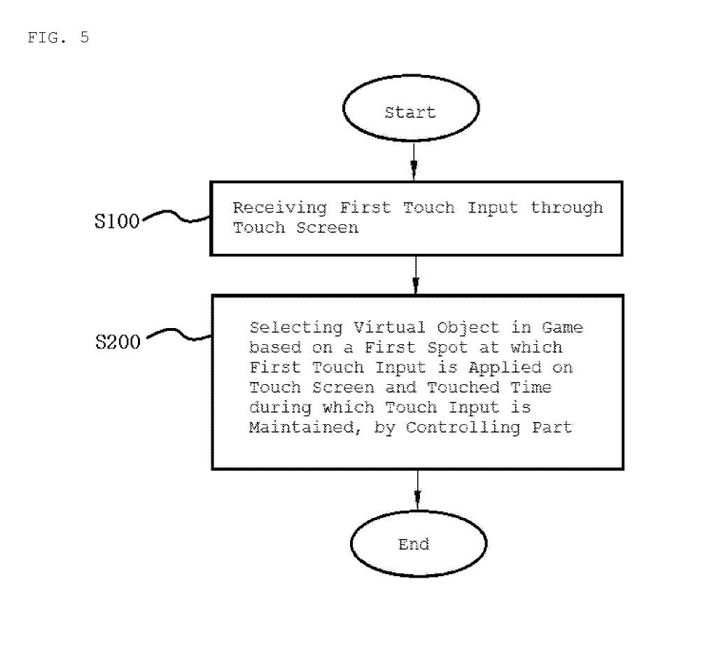

FIG. 4 illustrates another method for setting a selection area according to the present invention. After a first touch is maintained for a predetermined time at a first spot at which the first touch is input, the area setting part 20 may set a closed area based on a path 1 in which a touched position has moved from the first spot and set the closed area as the selection area. Even though the movement path of the user's touch has not completed the closed area, the area setting part 20 may set a closed area X4 as the selection area by connecting a starting spot 3 to an ending spot 4. Thus, the user may select only a specific plurality of virtual objects on his or her own.

FIG. 5 is a flowchart illustrating a method for controlling a virtual object based on a touched time according to an embodiment of the present invention. Referring to FIG. 5, the touched time-based virtual object control method includes a step for receiving a first touch input through a touch screen (S100) and selecting a virtual object in a virtual space based on a first spot at which the first touch input has been applied and a touched time during which the first touch has been maintained by a controlling part (S200). The afore-described touched time-based virtual object control apparatus may perform the touched time-based virtual object control method. The controlling part may be a computable processor such as a CPU, in which the afore-described touch recognizing part 10, area setting part 20, and virtual object selecting part 30 are incorporated.

The touched time-based virtual object control method may further include a step for extending a virtual object selection range with respect to the first spot based on the touched time by the controlling part. Or the touched time-based virtual object control method may further include a step for extending the virtual object selection range with respect to a second spot different from the first spot based on the touched time by the controlling part.

The first spot may be a part of a function menu on the touch screen, and the second spot may be a specific virtual object. As described above, the function menu may be a predetermined virtual button included in the virtual space manipulation unit. Further, the virtual object may be, but not limited to, a character or a building in a virtual space.

Meanwhile, if a second touch input is applied at a third spot after at least one virtual object is selected, the controlling part may control the selected virtual object to move to or attack the third spot. The third spot is a spot accessible to the virtual object. On the other hand, if a second touch input is applied at a third spot after at least one virtual object is selected, the controlling part may cancel the selection. Herein, the third spot may be a point inaccessible to the virtual object. The inaccessible point may include a case in which another object not capable of executing a unique function such as attack or constructing a building as well as a case in which the virtual object cannot move to the point.

According to another embodiment of the present invention, a computer program may include commands to perform the afore-described touched time-based virtual object control method.

According to another embodiment of the present invention, the above described computer program may be stored in a computer-readable recording medium.

As is apparent from the foregoing description, the present invention advantageously enables fast and convenient selection of a plurality of virtual objects on a touch screen. Particularly, a plurality of objects can be selected during implementation of a virtual space, without entering any additional selection mode.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. An apparatus for controlling a virtual object based on a touched time, the apparatus comprising:
a touch recognizing part configured to recognize a touch input on a touch screen; and
an area setting part configured to set a selection area in a virtual space based on the touch input,
wherein the area setting part sets the selection area based on a first spot and a touched time, the first spot being a spot at which a first touch input is applied on the touch screen and the touched time being a time period during which the first touch input is maintained.

2. The apparatus according to claim 1, further comprising a virtual object selecting part configured to select a virtual object in the selection area.

3. The apparatus according to claim 1, wherein the area setting part extends the selection area with respect to the first spot based on the touched time.

4. The apparatus according to claim 1, wherein the area setting part extends a virtual object area with respect to a second spot different from the first spot based on the touched time.

5. The apparatus according to claim 4, wherein the first spot is a part of a function menu on the touch screen, and the second spot is a predetermined virtual object.

6. The apparatus according to claim 1, wherein the virtual object includes a virtual character or a building in the virtual space.

7. The apparatus according to claim 1, further comprising a virtual object controlling part configured to, if at least one virtual object is selected and then a second touch input is applied at a third spot, control the selected virtual object to move to or attack the third spot,
wherein the third spot is a spot accessible to the virtual object.

8. The apparatus according to claim 1, further comprising a virtual object controlling part configured to, if at least one virtual object is selected and then a second touch input is applied at a third spot, cancel the selection,
wherein the third spot is a spot inaccessible to the virtual object.

9. A method for controlling a virtual object based on a touched time, the method comprising:
receiving a first touch input through a touch screen; and
selecting a virtual object in a virtual space based on a first spot and a touched time by a controlling part, the first spot being a spot at which a first touch input is applied on the touch screen and the touched time being a time period during which the first touch input is maintained.

10. The method according to claim 9, further comprising:
extending an object selection range with respect to the first spot based on the touched time.

11. The method according to claim 9, further comprising:
extending the virtual object selection range with respect to a second spot different from the first spot based on the touched time.

12. The method according to claim 11, wherein the first spot is a part of a function menu on the touch screen, and the second spot is a predetermined virtual object.

13. The method according to claim 9, wherein the virtual object includes a virtual character or a building in the virtual space.

14. The method according to claim 9, wherein if at least one virtual object is selected and then a second touch input is applied at a third spot, the controlling part controls the selected virtual object to move to or attack the third spot, and
wherein the third spot is a spot accessible to the virtual object.

15. The method according to claim 9, wherein if at least one virtual object is selected and then a second touch input is applied at a third spot, the controlling part cancels the selection, and
wherein the third spot is a spot inaccessible to the virtual object.

16. A computer program including a command to perform the method of claim 9.

17. A computer program including a command to perform the method of claim 10.

18. A computer program including a command to perform the method of claim 11.

19. A computer program including a command to perform the method of claim 12.

20. A computer program including a command to perform the method of claim 13.

21. A computer program including a command to perform the method of claim 14.

22. A computer program including a command to perform the method of claim 15.
